(19) United States
(12) Patent Application Publication
(10) Pub. No.: US 2011/0321102 A1
(43) Pub. Date: Dec. 29, 2011

(54) PROCESS FOR LOCALLY DIFFUSING THE AUDIO/VIDEO CONTENT BETWEEN A SOURCE DEVICE INCLUDING A HDMI CONNECTOR AND A RECEPTOR DEVICE

(75) Inventors: Jean-Pierre Morard, Rueil-Malmaison (FR); Jean-Marc Nogier, Rueil-Malmaison (FR)

(73) Assignee: SAGEMCOM BROADBAND SAS, Rueil Malmaison (FR)

(21) Appl. No.: 13/142,789

(22) PCT Filed: Dec. 24, 2009
(86) PCT No.: PCT/FR09/52701

§ 371 Date: Sep. 12, 2011

(30) Foreign Application Priority Data
Dec. 31, 2008 (FR) 0859160

(51) Int. Cl. H04N 7/18

(52) U.S. Cl. 725/81; 725/78

(57) ABSTRACT

A method for locally broadcasting audio/video content between a source device equipped with an HDMI interface and a target device, the method including: compressing the audio/video content in the source device; transmitting the compressed audio/video content over a wireless link, from a transmitter associated with the source device, the transmitter receiving the audio/video content from the HDMI interface of the source device, and receiving the compressed audio/video content using a receiver device.

### TECHNICAL FIELD OF THE INVENTION

The object of the present invention is a method for locally broadcasting audio/video type content between a source, equipped with an HDMI connector and a receiver, with the purpose of restoring the content broadcast over a television type device, for example. Essentially, the objective of the invention is to make the broadcasting of audio/video content over short distances, typically within a residence, i.e., local broadcasting, possible from any electronic equipment equipped with an HDMI connector.

In general, the field of the invention is that of the transmission of audio/video content. The expression “transmission of audio/video content” generally relates to the transmission of data relative to images and/or sounds intended to be restored by means of an electronic apparatus. Within a residence, it may be interesting to broadcast the audio/video content from a first piece of equipment storing or having an audio/video content to a piece of remote recipient equipment.

### TECHNOLOGICAL BACKGROUND OF THE INVENTION

Today, almost all potentially transmitting equipment is equipped with an HDMI (High Definition Multimedia Interface, in French: Interface Multimedia Haute Définition) connector. HDMI interfaces are entirely digital audio/video interfaces usually used to transmit uncompressed encrypted network traffic. HDMI interfaces enable a DRM type audio/video source—such as a Blu-Ray or HD DVD reader—to be connected to a computer or game console—with a compatible receiver—such as a High Definition television.

Now the possibility of using HDMI interfaces to transmit signals wirelessly exists. The rate is then on the order of 5 GHz (Giga Hertz), which is not sufficient for transmitting signals that usually pass through HDMI interfaces in wi-fi.

### GENERAL DESCRIPTION OF THE INVENTION

The method according to the invention proposes a solution to the problem that has just been stated. In the invention, a solution is proposed to make possible the transmission over a wireless link, for example wi-fi, of signals that have passed through HDMI interfaces. For this purpose, compressing signals corresponding to the audio/video content before passing it through an HDMI interface is particularly proposed in the invention.

The invention thus essentially relates to a method for locally broadcasting audio/video content between a source device equipped with an HDMI interface and a target device, characterized in that the method comprises the different steps consisting of:
compressing the audio/video content in the source device;
transmitting said compressed audio/video content, for example of the wi-fi type, over a wireless link, from a transmitter associated with the source device, said transmitter receiving the audio/video content from the HDMI interface of said source device;
receiving the compressed audio/video content by means of the receiver device.

The method according to the invention may comprise, in addition to the main steps that have just been mentioned in the previous paragraph, one or more additional characteristics from among the following:
the method comprises the additional step consisting of, prior to the step of transmitting over a wireless link, for example of the wi-fi type, encapsulating, within the source device, compressed audio/video content frames in HDMI frames;
the HDMI frames encapsulating the audio/video content frames are frames reserved for the transport of data type information;
the step consisting of transmitting over a wireless link, for example of the wi-fi type, said compressed audio/video content is preceded by a step consisting of de-encapsulating, within the transmitter, the encapsulated frames of the compressed audio/video content;
the step consisting of receiving the compressed audio/video content comprises the operation consisting of receiving the compressed audio/video content by means of a reception module comprising a DCB-VI or USB type interface, said reception module being integrated in the target device;
the step consisting of receiving the compressed audio/video content comprises the different operations consisting of:
receiving the compressed audio/video content in the region of a reception module associated with the target device;
encapsulating, within the reception module, compressed audio/video content frames in HDMI frames;
transmitting frames encapsulated within the reception module to an HDMI interface of the target device.
the step consisting of receiving the compressed audio/video content comprises the different operations consisting of:
receiving the compressed audio/video content in the region of a reception module associated with the target device;
decoding the compressed audio/video content by means of a decoding device of the reception module to obtain a decompressed audio/video content;
transmitting the audio/video content to an HDMI interface of the target device.

The different additional characteristics of the method according to the invention, insofar as they are not mutually exclusive, are combined according to all combination possibilities to result in different examples of embodiment of the invention.

The invention and its various applications will be better understood upon reading the following description and examining the accompanying figures.

### BRIEF DESCRIPTION OF THE FIGURES

The figures are only presented for indicative purposes and in no way limit the scope of the object of the present invention. The figures show:

FIG. 1: a representation of devices capable of implementing different variations of the method according to the invention;

FIG. 2: An example of the encapsulation of the audio/video content used in certain embodiments of the method according to the invention.

### DESCRIPTION OF PREFERRED FORMS OF EMBODIMENT OF THE INVENTION

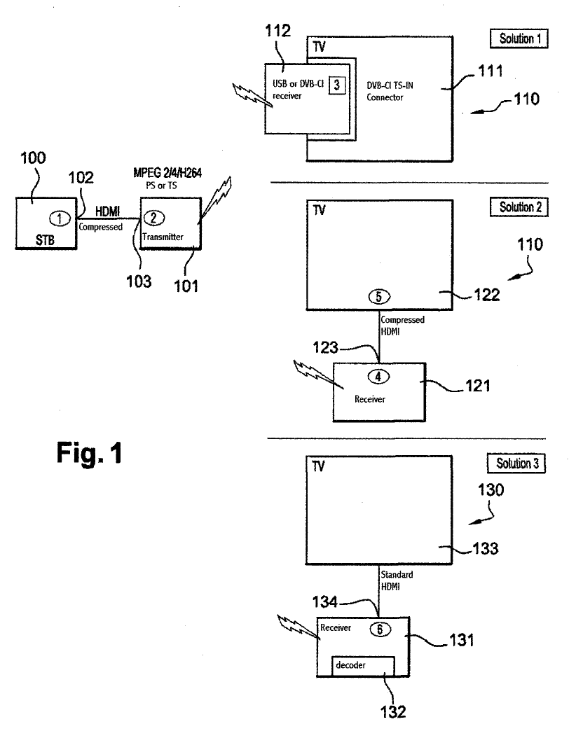

FIG. 1 shows different examples of devices capable of implementing different variations of the method according to the invention.

In FIG. 1, a source device 100, for example of the television decoder type, is associated with an audio/video content transmission module 101.

According to a first embodiment of the method according to the invention, signals transmitted by transmitter 101 are received by a target device 110, constituted of a television 111 integrating a reception module 112 of the DVB-CI or USB type.

According to a second embodiment of the method according to the invention, signals transmitted by transmitter 101 are received by a target device 120, constituted of a reception module 121 connected to a television 122.

According to a third embodiment of the method according to the invention, signals transmitted by transmitter 101 are received by a target device 130, constituted of a reception module 131, integrating a decoding module 132, said reception module 131 being connected to a television 133.

The different variations of embodiment of the method according to the invention are detailed here:

In the first embodiment, the following different steps are distinguished, each of the steps themselves comprising different steps or operations, the numbers of the steps referring to the references present in FIG. 1:

### Step 1:

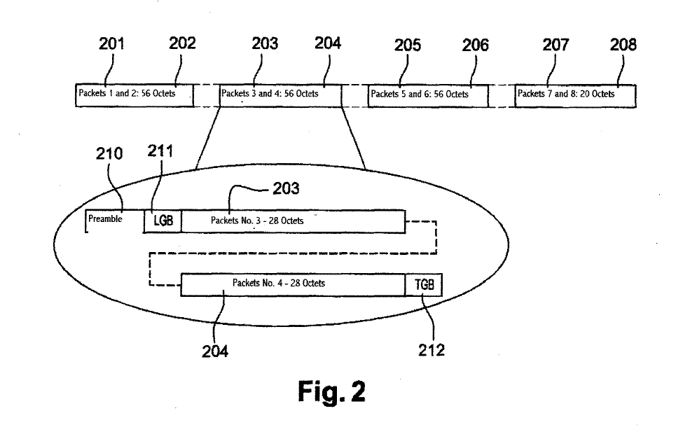

Compression of the audio/video content to be transmitted, or recovery of such content if it is already available within the source device 100. A compressed audio/video content is then obtained organized according to the TS (Transport Stream) or PS (Program Stream) type frames.
Encapsulation of TS/PS frames in the HDMI frame structure, according to the method that will be described with reference to FIG. 2.
Transmission of HDMI frames, comprising the compressed audio/video content, for a particular period of the HDMI protocol, known as the “data island” period, from an HDMI interface 102 to transmitter 101

### Step 2:

Reception of HDMI frames in the region of HDMI interface 103 of transmitter 101.
De-encapsulation of HDMI frames received to restore compressed traffic organized according to PS or TS type frames
Transmission of the de-encapsulated audio/video content via a wireless transmission system (WIFI, UWB, etc.) or possibly via no new wires transmission (by carrier currents or PLC)

### Step 3:

Reception of the de-encapsulated compressed audio/video content by the reception module 112. Reception module 112 comprises a DVB-CI or USB type interface
Injection over one of the physical inputs of television 111

In the second embodiment, the following different steps are distinguished, each of the steps themselves comprising different steps or operations:

### Step 1:

Identical to the first embodiment

### Step 2:

Identical to the first embodiment

### Step 4:

Reception of the de-encapsulated compressed audio/video content by reception module 121.
Encapsulation of TS/PS frames in the HDMI frame structure, according to the method that will be described with reference to FIG. 2.
Transmission of HDMI frames, comprising the compressed audio/video content, for a particular period of the HDMI protocol, known as the “data island” period, from an HDMI interface 123 to television 122

### Step 5:

Injection over one of the physical inputs of television 122. Decompression operations are then carried out within television 122 by an integrated decoding module.

In the third embodiment, the following different steps are distinguished, each of the steps themselves comprising different steps or operations:

### Step 1:

Identical to the first embodiment

### Step 2:

Identical to the first embodiment

### Step 6:

Reception of the de-encapsulated compressed audio/video content by the reception module 131.
Decoding the de-encapsulated audio/video content by means of a decoding module 132 to obtain a decompressed audio/video/data stream;
Standard injection through an HDMI interface 134 of the reception module 131 to television 133

FIG. 2 represents an example, applicable to TS frame type frames containing the compressed audio/video content, of encapsulation of frames with compressed audio/video content in the structure of HDMI frames.

Typically, a TS frame has a size of 188 octets. Thus, to encapsulate a TS frame in the frames used according to the HDMI protocol, TS type frames are cut. Advantageously, in the invention, using HDMI frames usually used for the transmission of data type information (information different from audio and/or video content) is chosen. These frames have a size of 28 octets, and are necessarily transmitted in pairs. Thus, it is necessary, for a TS frame, to have eight HDMI frames, the first six frames 201 to 206 being entirely filled (28 octets), the seventh frame 207 being partially filled (20 octets) while the eighth frame 208 is left empty.

FIG. 2 illustrates the fact that each of the HDMI frames comprises a preamble 210 indicating the nature of the data that will follow, and either an LGB indicator 211 or a TGB indicator 212, known from the HDMI protocol. Preamble 210 is advantageously utilized by utilizing an unreserved value in order to indicate that the data transported in the frame under consideration corresponds to the compressed audio/video content.

1. A method for locally broadcasting audio/video content between a source device equipped with an HDMI interface and a target device, the method comprising:
compressing the audio/video content in the source device;
transmitting said compressed audio/video content over a wireless link, from a transmitter associated with the source device, said transmitter receiving the audio/video content from the HDMI interface of said source device, and
receiving the compressed audio/video content using a receiver device.

2. The method according to claim 1, comprising, prior to the transmitting over the wireless link, encapsulating, within the source device, compressed audio/video content frames in HDMI frames.

3. The method according to claim 3, wherein the HDMI frames encapsulating the audio/video content frames are frames reserved for the transport of data type information.

4. The method according to claim 2, wherein transmitting by wireless link said compressed audio/video content is preceded by de-encapsulating within the transmitter the encapsulated frames of the compressed audio/video content.

5. The method according to claim 1, wherein receiving the compressed audio/video content comprises receiving the compressed audio/video content using a reception module comprising a DCB-VI or USB type interface, said reception module being integrated in the target device.

6. The method according to claim 2, wherein receiving the compressed audio/video content comprises:
receiving the compressed audio/video content in a region of a reception module associated with the target device;
encapsulating, within the reception module associated with the target device, compressed audio/video content frames in HDMI frames;
transmitting frames encapsulated within the reception module to an HDMI interface of the target device,

7. The method according to claim 2, wherein receiving the compressed audio/video content comprises:
receiving the compressed audio/video content in a region of a reception module associated with the target device;
decoding the compressed audio/video content using a decoding device of the reception module to obtain a decompressed audio/video content;
transmitting the audio/video content to an HDMI interface of the target device.
